(19) United States
(12) Patent Application Publication
(10) Pub. No.: US 2006/0210697 A1
(43) Pub. Date: Sep. 21, 2006

(54) INFANT FORMULA COMPOSITION

(76) Inventor: Thomas E. MOWER, Payson, UT (US)

Correspondence Address: STARKWEATHER & ASSOCIATES, 9035 SOUTH 1300 EAST, SUITE 200, SANDY, UT, 84094, US

(21) Appl. No.: 11/307,036

(22) Filed: Jan. 19, 2006

Related U.S. Application Data
(63) Continuation-in-part of application No. 11/083,826, filed on Mar. 18, 2005.

(51) Int. Cl. A23G 3/00

(52) U.S. Cl. 426/658; 426/656; 426/601

(57) ABSTRACT

An infant formula composition including fucoidan, a protein, and a lipid. The fucoidan may be partially hydrolyzed, and also may be sulfonated. The protein may be derived from quinoa. Also disclosed are infant formula kits to be assembled in the field. The kits may include a substantially dehydrated infant formula composition and a diluting agent. The kit may alternatively include a ready-to-consume infant formula composition and substantially dehydrated additives which may be added to the formula before consumption.

This application is a Continuation-in-Part of, and claims the benefit of application Serial No. 11/083,826, filed on 18 Mar. 2005, by Thomas E. Mower, entitled Fucoidan Compositions and Methods for Dietary and Nutritional Supplements, the entirety of which is herein incorporated by reference.

### BACKGROUND OF THE INVENTION

1. Field of the Invention

The present invention relates generally to infant formula compositions, and, more particularly, to infant formula compositions which include fucoidan.

2. Description of the Related Art

Of the stages of human development, the most important stages have been said to be those at the beginning of life. Because the early stages of life are important for the future and development of the baby, it is important that the baby receive adequate nutrition, and even nutrition that assists in the development of the baby. Physicians and dietitians typically agree that the proper diet for an infant is that provided by nature, and often the most convenient for the mother and baby, that is, human milk.

Human milk typically contains all of the essential nutrients in the necessary proportions needed for proper development of the infant. Human milk may even change in composition as the infant ages. For example, the first human milk that is provided is known as colostrum, which is followed by a mature milk. Human milk contains the ω-3 fatty acid, docosahexaenoic acid (DHA). Human milk typically includes about 3 percent fats, 7.5 percent carbohydrates, 1.2 percent proteins, and 0.25 percent mineral salts. The proteins include casein and lactalbumen, in the amounts of about 0.4 and 0.8 percent of the milk, respectively.

There are many reasons or situations in which an infant is not given human milk. For example, some mothers are not capable of producing milk, or the mother has other reasons for not providing human milk for the infant, such as lack of time, fear of harm to her body and/or breasts, inconvenience, and so forth. Alternatively, the mother may not be available to the infant because of adoption, hospitalization of the mother, and so forth. Further, after a certain period of time, the child is not given human milk, and moves on to eating other foods.

As a result of babies not being fed human milk, another form of aliment must be available to the baby. One popular aliment is cows milk. Though relatively convenient in many parts of the world, cows milk is not the best substitute for human milk, especially for infants. Cows milk contains about 4 percent fat, 4 percent carbohydrates, 4.3 percent protein, and 0.65 percent mineral salts. Further, the cows milk includes about 4 percent casein and 0.3 percent lactalbumen. As such, cows milk contains fewer carbohydrates, much more casein, and less lactalbumen than human milk. Another nutrient that babies need, and is available in human milk is the DHA.

What is needed is an infant formula capable of replacing human milk, and an infant formula formula capable of maintaining the nutritional benefits of human milk in the food-based diet of the baby. Some researchers have found ways to modify cows milk, or create a food that is more akin to human milk. This research is represented in the following patents and patent applications.

An infant formula the mimics human milk is difficult to produce because of the difficulty to produce many of the components of human milk, especially the living cells that may be present in human milk, and components with unique molecular formulas that are difficult to reproduce. Further, infant formula typically must be preserved before it is consumed. The requirements for preservation of the infant formula make it difficult for the infant formula to mimic human milk.

For example, Masor discloses, in U.S. Pat. No. 5,700,590, an improved enteral formula containing ribo-nucleotide equivalents (RNA, mono-, di- and triphosphate nucleotides, nucleosides and adducts such as activated sugars) at a level of at least 10 mg/100 Kcal (kilocalorie) of formula. More specifically, an infant formula containing at least 10 milligrams of nucleotide equivalents per 100 Kcal of formula where the nucleotide equivalents consist of RNA; mono-, di-, and triphosphate esters of adenosine, cytidine, guanosine, and uridine, and the d-ribose adducts thereof; and wherein the weight ratio of said cytidine nucleotide equivalents to said uridine nucleotide equivalents is 1.5:1 to 2.6:1; of said cytidine nucleotide equivalent to said adenosine nucleotide equivalents is 2:1 to 3.9:1; and of said cytidine nucleotide equivalents to said guanosine nucleotide equivalents is 1.75:1 to 2.8:1, is disclosed. The formula comprises carbohydrates, lipids, proteins, vitamins and minerals and four (4) ribo-nucleotide equivalents at specific levels and ratios. This invention also provides a dietary formula that enhances the immune system and alleviates diarrhea.

In a further example, Borschel discloses in U.S. Pat. No. 5,021,245, which is herein incorporated by reference, a novel liquid nutritional for use as an infant formula for use in the treatment of infantile colic. The formula comprises protein, fat, carbohydrates and dietary fiber of a concentration of between 3.1 and 14.1 grams of fiber per liter of formula. Also disclosed is a method of treating infants with colic by feeding an infant the formula made in accordance with the invention. Also disclosed is a method for manufacturing the infant formula of the invention.

In yet another example, Nielsen discloses in U.S. Pat. No. 1,607,844, which is herein incorporated by reference, the production of a food for infants, children, and invalieds, and its principal object is to produce a food which shall have a nutritive value substantially equal to that of normal human milk. The production includes as its precursors: cows milk, cereals, sweet whey, mineral salts, orange juice, and vitamins.

In a further example, Theuer, et al. discloses, in U.S. Patent Application Publication 2003/0207004 infant formula compositions comprising about 5% to about 25% egg-yolk solids and an acidulant in an acceptable, shelf-stable, baby-food preparation. The acidulant can be an acid, a cultured food substance containing lactic acid, or a fruit or vegetable component which contributes acidity to the composition of a combination thereof. Also disclosed are methods for preparing and using the compositions. The egg-yolk solids can serve as delivery vehicles for nutrients such as the polyunsaturated fatty acid, DHA, if the eggs are produced by chickens fed diets high in DHA or DHA precursors.

Increasing the concentration of DHA in hen eggs is disclosed, for example, in U.S. Pat. No. 5,415,879 to Oh. According to the Oh patent, chickens are fed a composition including fish oil over a period of time. Modified eggs laid by such chickens contain substantial quantities of omega-3 polyunsaturated fatty acids. The modified eggs are fed to humans with the result that serum cholesterol, serum triglycerides and blood pressure are reduced as compared to humans eating a like number of regular eggs with a subsequent decrease in heart disease. The Theuer patent application publication also discusses the benefits of egg yolks as a part of an infant's diet. Theuer discloses that egg yolks contain substantial levels of nutrients such as high quality protein with all the essential amino acids, many vitamins and minerals, and polyunsaturated fatty acids.

In yet a further example, Theuer further discloses in U.S. Pat. No. 6,051,235, baby-food compositions containing ginger which can be used in reducing gastrophageal reflux in infants. The compositions can contain a ginger puree and one or more fruits or vegetables. Also disclosed are methods of making and using the compositions.

Baby foods may exist in several different forms. One need only peruse an “infants,” or “baby” isle of a supermarket to see the varieties of baby foods. For infants, there are formulas available. The formulas may be purchased for example, in ready-to-use (liquid) form or in powder form that can be dissolved in water before feeding to the infant. These formulas are sold, for example, under the tradename Enfamil® (Mead Johnson & Company, Evansville, Ind.). These formulas are available in several varieties, such as milk-based, soy-based, hypoallergenic (for allergies to cow's milk), low iron, lactose-free, sugar-free, including DHA, and so forth. Formulas are available for stages of the infant and/or child's life. For example, also available under the tradename Enfamil® is a broad range of products for various ages, such as Premature LIPIL® for premature infants, Enfamil® for infants, NEXT STEP® for toddlers of 9-24 months, and Kindercal for children up to the age of 10.

Other than formula-type infant and baby foods are semi-solid and solid foods for infants and children. Infants typically start eating solid or semi-solid foods at about the age of 6 months. Many of the foods available for this stage are available under the tradename Gerber® (Gerber Products Company, Freemont, Mich.). Some of the products available under the Gerber® tradename include juices, cereals, staged foods, finger foods, and organic foods. Some of the juices available include LiquiLites® liquid or powder (for dissolution with water) electrolytes, fruit juices, vegetable juices, and juice and yogurt blends. Some of the cereals available include rice cereals, oatmeal cereals, barley cereals, cereals with fruit, cereals made with the ingredients of formula, and mixtures of grains and fruits. Typically the cereals are sold in a dehydrated form (flakes or powders) for rehydration prior to feeding the baby. Many of the cereals available are fortified with vitamins and/or minerals that may be necessary for the development of the baby.

Staged foods come with different ingredients, viscosity, content of solids/chunks, and so forth. For example, under the tradename of Gerber® is available 1^{st} Foods® which are purees of cooked and fortified vegetables or fruits. 2^{nd} Foods® include prepared cereals, fruits, vegetables, dinners (which include meats), meats, desserts, and tropical fruit desserts. These also may be fortified with vitamins and/or minerals. Further available under the Gerber® tradename are 3^{rd} Foods® including prepared cereals, fruits, vegetables, dinners, desserts, and entrees. The entres include separate sections of different foods.

Also available are “finger foods”. Generally, finger foods include any food that the baby can pick up and feed himself. Some examples of finger foods are available under the tradename Gerber®. These include fruit puffs, veggie puffs, biter biscuits, zwieback toast, veggie wagon wheels, and fruit wagon wheel. These foods are somewhat solid, and shaped such that the baby can pick them up and eat.

One goal common to most infant formulas is to include nutrients that the baby needs. Some examples of such nutrients include DHA, the ω-3 fatty acid, arachidonic acid (ARA), vitamins, minerals such as iron, and so forth. Many infant formulas are available that are supplemented with vitamins, minerals, DHA, and/or ARA. For example, infant formulas sold under the tradename Beech Nut® (Canajoharie, N.Y.), such as First Advantages contain both DHA and ARA.

Though there are many available infant formulas with different nutritive advantages, consumer demand for natural-based products has been growing in recent years. Chemical synthesis is perceived as environmentally unsafe. A chemically synthesized ingredient may contain harsh chemicals. Natural products are perceived as more pure and mild, and thus superior to chemically synthesized products. Delivering a dietary benefit to babies from plant sources, however, is not trivial. To derive a real benefit from a natural source, not only does a plant or a part of the plant containing a specific active ingredient have to be identified, but a minimum concentration and/or a specific extract of that plant has to be identified that truly delivers a dietary benefit to babies.

Accordingly, consumers demand an effective infant formula composition that helps with growth, mental stimulation, proper development, assistance with the immune system, and does not upset the stomach. Further, consumers demand that the infant formula composition be based on natural products to promote the beneficial effects herein described.

Fucoidan is a sulfated polysaccharide found in many sea plants and animals, and is particularly concentrated in the cell walls of brown algae (Phaeophyceae). Fucoidan is a complex carbohydrate polymer composed mostly of sulfated L-fucose residues. These polysaccharides are easily extracted from the cell wall of brown algae with hot water or dilute acid and may account for more than 40% of the dry weight of isolated cell walls. O. Berteau & B. Mulloy, Sulfated Fucans, Fresh Perspectives: Structures, Functions, and Biological Properties of Sulfated Fucans and an Overview of Enzymes Active Toward this Class of Polysaccharide, 13 Glycobiology 29R-40R (2003). Fucoidan structure appears to be linked to algal species, but there is insufficient evidence to establish any systematic correspondence between structure and algal order. High amounts of α(1-3) and α(1-4) glycosidic bonds occur in fucoidans from Ascophyllum nodosum. A disaccharide repeating unit of alternating α(1-3) and α(1-4) bonds represents the most abundant structural feature of fucoidans from both A. nodosum and Fucus vesiculosus, which are species of seaweed. Sulfate residues are found mainly in position 4. Further heterogeneity is added by the presence of acetyl groups coupled to oxygen atoms and branches, which are present in all the plant fucoidans. Following is a representation of A. nodosum fucoidan:

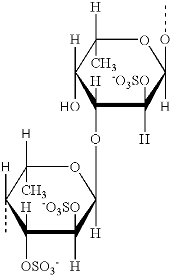

Fucoidan-containing seaweeds have been eaten and used medicinally for at least 3000 years in Tonga and at least 2000 years in China. An enormous amount of research has been reported in the modern scientific literature, where more than 500 studies are referenced in a PubMed search for fucoidan.

The physiological properties of fucoidans in the algae appear to be a role in cell wall organization and possibly in cross-linking of alginate and cellulose and morphogenesis of algal embryos. Fucoidans also have a wide spectrum of activity in biological systems. They have anticoagulant and antithrombotic activity, act on the inflammation and immune systems, have antiproliferative and antiadhesive effects on cells, and have been found to protect cells from viral infection.

Further, fucoidan has numerous beneficial functions that heal and strengthen different systems of the body, including anti-viral, anti-inflammatory, anti-coagulant, and anti-tumor properties. A. I. Usov et al., Polysaccharides of Algae: Polysaccharide Composition of Several Brown Algae from Kamchatka, 27Russian J. Bio. Chem. 395-399 (2001). Fucoidan has been found to build and stimulate the immune system. Research has also indicated that fucoidan reduces allergies, inhibits blood clotting, fights diabetes by controlling blood sugar, prevents ulcers, relieves stomach disorders, reduces inflammation, protects the kidneys by increasing renal blood flow, and detoxifies the body. Fucoidan also helps to reduce and prevent cardiovascular disease by lowering high cholesterol levels and activating enzymes involved in the beta-oxidation of fatty acids.

A Japanese study found that fucoidans enhanced phagocytosis, the process in which white blood cells engulf, kill, digest, and eliminate debris, viruses, and bacteria. An American study reported that fucoidans increased the number of circulating mature white blood cells. An Argentine study and a Japanese study found that fucoidans inhibited viruses, such as herpes simplex type I, from attaching to, penetrating, and replicating in host cells. A Swedish study is among the many that showed fucoidans inhibit inflammation cascades and tissue damage that may lead to allergies. Other studies, such as one in Canada, found that fucoidans block the complement activation process that is believed to play an adverse role in chronic degenerative diseases, such as atherosclerosis, heart attack, and Alzheimer's disease. Two American studies found that fucoidans increase and mobilize stem cells.

Researchers have also determined that fucoidan tends to combat cancer by reducing angiogenesis (blood vessel growth), inhibiting metastasis (spreading of cancer cells to other parts of the body), and promoting death of cancer cells. Certain societies that make brown seaweed part of their diet appear to have remarkably low instances of cancer. For example, the prefecture of Okinawa, where the inhabitants enjoy some of the highest life expectancies in Japan, also happens to have one of the highest per capita consumption rates of fucoidans. It is noteworthy that the cancer death rate in Okinawa is the lowest of all the prefectures in Japan.

Brown seaweed, a ready source of fucoidan, is found in abundance in various ocean areas of the world. One of the best locations that provides some of the highest yields of fucoidan is in the clear waters surrounding the Tongan islands, where the seaweed is called limu moui. In Japan, hoku kombu (Laminaria japonica), is said to be particularly rich in fucoidans and is similar to limu moui. The Japanese also consume at least two other types of brown seaweed-wakame and mozuku (Cladosiphon and Nemacystus).

Typically, aboeut four percent by weight of Tongan limu moui is fucoidan. There are at least three types of fucoidan polymer molecules found in brown seaweed. U-fucoidan, having about 20 percent glucuronic acid, is particularly active in carrying out cancer cell destruction. F-fucoidan, a polymer of mostly sulfated fucose, and G-fucoidan, which contains galactose, both tend to induce the production of HGF cells that assist in restoring and repairing damaged cells. All three types of fucoidan also tend to induce the production of agents that strengthen the immune system.

The available infant formulas lack some of the essential benefits needed by infants. For example, currently available infant formulas do not sufficiently mimic human milk. Further, currently available infant formulas may include some synthesized components. Still further, currently available infant formulas may not assist in regenerating damaged cells and tissues, promote growth factors, are high in antioxidants, help fight free radicals, and/or slow the unwanted aging processes.

What is needed is an infant formula composition that solves one or more of the problems described herein and/or one or more problems that may come to the attention of one skilled in the art upon becoming familiar with this specification. One of such problems is providing an infant formula composition that assists in anti-aging, regeneration of cells and tissues such as muscles and/or bones, promoting growth factors, promoting vitality and youthfulness, strengthening the immune system, reducing allergies, inhibiting blood clotting, controlling blood sugar, preventing ulcers, reliving stomach disorders, reducing inflammation, protecting the kidneys, lowering cholesterol levels, inhibiting smooth muscle cell proliferation, activating enzymes involved in the beta-oxidation of fatty acids and/or detoxifying the body. Another problem is in providing an infant formula composition that includes a natural ingredient that more closely mimic's the effects of human milk.

### SUMMARY OF THE INVENTION

The present invention has been developed in response to the present state of the art, and in particular, in response to the problems and needs in the art that have not yet been fully solved by currently available infant formula compositions. Accordingly, the present invention has been developed to provide an infant formula composition comprising: fucoidan, a protein, and a lipid.

The fucoidan may be partially hydrolyzed. The fucoidan may be sulfonated. The fucoidan may be a derivative of one of the group of: Japanese mozuku seaweed, Japanese kombu seaweed, Tongan limu moui seaweed, and combinations thereof. The protein may be a derivative of quinoa. The infant formula composition may further include an ω-3 fatty acid.

According to another embodiment, the present invention includes a concentrated infant formula composition kit that can be mixed in the field, wherein the kit includes: a concentrated infant formula composition, comprising fucoidan and a lipid; and a diluting agent.

The diluting agent may include water and a mineral. The diluting agent may be water and a vitamin. The concentrated infant formula composition may be substantially dehydrated. The concentrated infant formula may be a concentrated liquid. The fucoidan may be partially hydrolyzed. The fucoidan may be sulfonated. The kit may further include a protein derived from quinoa.

According to yet another embodiment, the present invention includes an infant formula composition kit that can be mixed in the field, wherein the kit includes: an infant formula composition, comprising fucoidan and a lipid; and an additive in concentrated form.

The fucoidan may be partially hydrolyzed. The fucoidan may be sulfonated. The infant formula composition may further include a protein derived from quinoa. The additive may include a protein derived from quinoa. The additive may include dietary fiber.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

In describing and claiming the present invention, the following terminology will be used in accordance with the definitions set out below.

As used herein, “comprising,” “including,” “containing,” “is,” “are,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “partially hydrolyzed fucoidan” means fucoidan that has been hydrolyzed into smaller polymers and oligomers, but not so thoroughly hydrolyzed as to result in complete hydrolysis to substantially primarily monosaccharides.

As used herein, “baby” means an infant, toddler, or child. Unless the terms “infant,” “toddler,” or “child” are used, then all three are assumed, and contained within the term “baby”.

As used herein, “ORAC” means “oxygen radical absorbance capacity.”

As used herein, “high ORAC value” or similar terms means an ORAC value of at least about 400 per 100 grams of fruit or vegetable. For example, blueberries have an ORAC value of about 2,400 per 100 grams, and the following fruits have ORAC values as shown in parentheses per 100 grams: blackberries (2,036), cranberries (1,750), strawberries (1,540), raspberries (1,220), plums (949), oranges (750), red grapes (739) cherries (670), kiwi fruit (602), and white grapes (446). Other fruits known to have a high ORAC value include black grapes, mangosteen, noni, aronia, wolfberry, and acai, and the like. Further, nutraceutical ingredients known to have high ORAC values include proanthocyanidins, such as from extracts of grape seed and bark of white pine of southern Europe (e.g., pycnogenol, U.S. Pat. No. 4,698,360), and curcuminoids. Oligomeric proanthocyanidins (OPC) are illustrative.

As used herein, “Brix” is a scale for measuring the sugar content of grapes, wine, and the like. Each degree of Brix is equivalent to one gram of sugar per 100 ml of liquid. Thus, an 18 degree Brix sugar solution contains 18% by weight of sugar. Brix also describes the percent of suspended solids in a liquid. Thus, 95 Brix, for example, denotes a liquid that contains 95% by weight of suspended solids. Brix is measured with an optical device called a refractometer. The Brix system of measurement is named for A. F. W. Brix, a 19^{th} century German inventor.

As used herein, “pasteurization” means a process named after scientist Louis Pasteur to destroy harmful bacteria that may be present without substantially affecting flavor and food value. For example, one pasteurization process includes heating every particle of milk to not lower than 62.8° C. (i.e., 145° F.) for not less than 30 minutes and promptly cooling the milk. Currently, the most common method of pasteurization in the United States is High Temperature Short Time (HTST) pasteurization, which uses metal plates and hot water to raise temperatures to 71.7° C. (i.e., 161° F.) for not less than 15 seconds, followed by rapid cooling. Ultra Pasteurization (UP) is a process similar to HTST pasteurization, but using higher temperatures and longer times. UP pasteurization results in a product with longer shelf life but still requiring refrigeration of milk, but not of acidified foods or nutritional supplements (pH <4.6). Another method, Ultra High Temperature (UHT) pasteurization, raises the temperature to over 93.3° C. (i.e., 200° F.) for a few seconds, followed by rapid cooling. A UHT-pasteurized product that is packaged aseptically results in a “shelf stable” product that does not require refrigeration until it is opened.

As used herein, “sterilizing” and similar terms means, with respect to nutritional supplements having a pH less than 4.6 and a water activity greater than 0.85, pasteurizing the nutritional supplement and storing at room temperature. With respect to nutritional supplements having a pH greater than 4.6 and a water activity greater than 0.85, “sterilizing” and similar terms mean applying heat such that the nutritional supplement is rendered free of microorganisms capable of reproducing in the nutritional supplement under normal non-refrigerated conditions of storage and distribution.

As used herein, “aseptic processing and packaging” and similar terms mean the filling of a sterilized cooled product into pre-sterilized containers, followed by aseptic hermetic sealing, with a pre-sterilized closure, in an atmosphere free of microorganisms.

As used herein, “hermetically sealed container” and similar terms mean a container that is designed and intended to be secure against the entry of microorganisms and thereby to maintain the sterility of its contents after processing.

The present invention is drawn toward infant formula compositions, which include fucoidan and a lipid. The composition may also include a protein, a carbyhydrate, DHA, AHA, and/or additional compounds.

Fucoidan

The present invention advances prior art infant formula compositions by providing an infant formula composition formulated with fucoidan from seaweed, such as limu moui, kombu, or mozuku. The addition of fucoidan to the infant formula composition of the present invention serves to provide significant advantages not found in prior art infant formula compositions. The fucoidan-enhanced infant formula compositions of the present invention provide many beneficial functions, including simulating human milk, providing for regeneration of cells and tissues; promoting youthfulness; reducing inflammation and the like. In addition, the fucoidan-enhanced infant formula compositions of the present invention minimize the unwanted visible signs of both biological and environmental aging. That is, the present dietary supplements slow the unwanted aging process, assist in regenerating damaged cells and tissues, and promote growth factors in the body. Fucoidan is high in antioxidants that help to fight free radical damage to the body that may lead to cancer. These antioxidants help to fight free radical damage caused by the sun and other changing environmental conditions and elements.

Brown seaweed, a source of fucoidan, grows in many oceans, including off the coasts of Japan and Okinawa, Russian coastal waters, Tonga, and other places. An excellent source of fucoidan is the limu moui sea plant growing in the waters of the Tongan islands. This brown seaweed contains many vitamins, minerals, and other beneficial substances and is particularly rich in fucoidan.

Typically, the brown seaweed grows in long angel hair stems with numerous leaves. The fucoidan ingredient is found in natural compositions on the cell walls of the seaweed, providing a slippery sticky texture that protects the cell walls from the sunlight.

In one embodiment, a kombu-type or mozuku-type seaweed is harvested from the coastal waters of the Tongan islands. These seaweeds can be manually harvested, including stems and leaves, by divers and cleaned to remove extraneous materials. The seaweed is then usually frozen in large containers and shipped to a processing plant.

In processing, the heavy outer fibers must first be broken down to provide access to the fucoidan component. If frozen, the seaweed material is first thawed. Then the seaweed material is placed in a mixing vat and shredded, while being hydrolyzed with acids and water. The material may optionally be sulfonated with sulfuric acid to help in breaking down the heavy cell fibers. The mixture may also be buffered with citric acid and thoroughly blended to maintain suspension. The material may also be heated at atmospheric or greater than atmospheric pressure while mixing. The resulting puree is tested and maintained at a pH of about 2 to 4 so as to remain acidic, enhancing preservative and stability characteristics.

The puree may be used in preparing infant formula compositions. Alternately, the mixture may be frozen in small containers for later processing. In another example, the puree may be dehydrated. The dehydration may be performed by any means known in the art of food processing, such as vacuum drying, spray drying, heating, freeze drying, and so forth. Dehydrated fucoidan may be in any form known in the art, such as, for example in the form of a powder, flakes, pellets, and so forth.

According to one embodiment, the present invention provides an infant formula composition formulated with fucoidan compositions from seaweed, such as the limu moui seaweed plant, the Japanese mozuku seaweed, or Japanese kombu seaweed, or mixtures thereof. In another embodiment, the fucoidan may be partially hydrolyzed fucoidan. In yet another embodiment, the fucoidan may be sulfonated. In still another embodiment, the fucoidan compositions are present in selected embodiments in the amount of at least about 0.05 weight percent, or at least about 3 weight percent, or at least about 5 weight percent; and less than about 100 weight percent, or less than about 80 weight percent, or less than about 50 weight percent of the total weight of the infant formula composition.

In a further embodiment, the partially hydrolyzed fucoidan may be derived from Tongan limu moui, Japanese hoku kombu (Laminaria japonica), wakame, or mozuku (Cladosiphon and Nemacystus). In still a further embodiment, the partially hydrolyzed fucoidan may be sulfonated.

Protein

The infant formula of the present invention may include at least about 0.01 weight percent, or at least about 5 weight percent, and less than about about 20 weight percent, or less than about 16 weight percent protein. Protein is an important building block of growing babies, and an important nutrient for life. Generally, proteins are high-molecular-weight organic compounds consisting of amino acids joined by peptide bonds. Amino acids have both a carboxyl group and an amino group. A peptide bond is a bond between the carboxyl group of one molecule and the amino group of another molecule. In food, proteins serve as the source of amino acids. Twenty amino acids make up DNA, are called standard amino acids, and include alanine, cysteine, aspartic acid, glutamic acid, phenylalanine, glycine, histidine, isoleucine, lysine, leucine, methionine, asparagine, proline, glutamine, arginine, serine, threonine, valine, tryptophan, and tyrosine.

Protein sources that contain any or all of the standard amino acids may be used in the infant formula of the present invention. Some protein sources include, for example, animal sources such as milks, meats, hooves, fish, and so forth; plant sources such as grains, cereals, soy, and so forth; synthesized; and so forth.

Cows milk may be a protein source for the infant formula of the present invention. U.S. Pat. No. 1,607,844 to Nielsen, herein incorporated by a reference, teaches a method of including proteins from cows milk for an infant formula. Further, the Nielsen patent discloses isolating the protein lactalbumen from sweet whey, and including this protein in the infant formula such that the balance of proteins more closely mimics that of human milk.

Some specific sources of protein that may be included in the infant formulas of the present invention may include, for example, soy protein (in the form of soybean meal, or soybean hulls, for example), isolated soy protein, whey protein, grain proteins (such as red wheat, white wheat, semolina, spelt, rye, barley, oat, rice, maize, millets, sorghums, triticale, teff, wild rice, quinoa, buckwheat, amaranth, cockscomb, and so forth), sodium caseinate, calcium caseinate, casein hydrolysate, whole milk, skim milk, buttermilk, condensed milk, evaporated milk, milk solids non-fat, pea proteins, hemp proteins, bean proteins, lupin proteins, rice protein, cottonseed meal, wheat middlings, corn byproducts, microbial protein (such as, for example, torula yeast, brewer's yeast, and so forth), meat meal, poultry meal, egg proteins, blood meal, feather meal, fish meal, and so forth.

On particularly good source of protein includes quinoa. Quinoa is the seed of a leafy plant that is related to spinach. Quinoa grows best in poor soil and in high altitudes. The ancient Incas cultivated and ate quinoa for many years. Quinoa is native of the Andes mountains, and is now cultivated in the higher elevations of the Rocky Mountains. Quinoa provides many nutrients needed not only by babies, but by all humans. Interestingly, quinoa includes the amino acid lysine, which most other grains and cereals lack. This makes the proteins of quinoa more complete, and more akin to the proteins of milk. Quinoa has more iron than many other cereals and grains. Quinoa is also an excellent source of potassium, riboflavin, vitamin B₆, niacin, thiamin, magnesium, zinc, copper, and manganese. These benefits make quinoa and derivatives thereof a good source of nutrients for the infant formula of the present invention. In one embodiment, the protein includes quinoa or a derivative thereof. The quinoa may be a quinoa flour, quinoa meal, and the like.

In another embodiment, the protein is a derivative of soy. Soy is another good source of proteins that are usable by infants. One particularly good source of protein from soy is soy protein isolate. Soy protein isolate is a product of defatted soy beans, which have had almost all of the other components of the soy bean removed. Most of the carbohydrates are also removed, resulting in a substantially taste-free substance. Soy protein isolate typically include at least about 90 weight percent protein. Soy protein isolate is commercially available in powder form from The Solae Company, St. Louis, Mo.

In yet another embodiment, the protein is a protein derived from milk. Milk derivatives include milk, milk powder, cheeses, yogurts, creams, butters, and the like. The milk may be any mammalian milk such as, for example, human milk, bovine milk, horses milk, goat milk, and the like. The protein may be a whole protein and/or a protein hydrolysate. Protein hydrolysates may be formed by hydrolyzing a material that includes a milk protein.

Lipid

The infant formula of the present invention may include at least about 0.01 weight percent, or at least about 5 weight percent, and less than about 50 weight percent, or less than about 25 weight percent of a lipid. Lipids are typically somewhat water insoluble or non-polar compounds of biological origin. Lipids include waxes, fatty acids, fatty-acid derived phospholipids, sphingolipids, glycolipids and terpenoids, such as retinoids and steroids.

The lipid may be derived from oleic oil, oleo oil, coconut oil, babassu oil, a seed oil such as soybean oil, corn oil, peanut oil, sunflower seed oil, safflower oil, cottonseed oil, milk fats, egg fats, and so forth, and/or derivatives thereof.

The lipid may be chosen from any of the edible fats and/or fatty acids known. Several lipids are discussed in patents and patent applications. One example is U.S. Pat. No. 6,863,918 to Bindels, which is herein incorporated by a reference. The lipids of this patent include all fatty acid triglycerides known for use in food products. Fatty acid triglycerides generally comprise a glyceride molecule to which are attached, by means of ester bonds, three fatty acid residues, which may be the same or different, and which are generally chosen from saturated and unsaturated fatty acids containing 6 to 26 carbon atoms, including but not limited to linoleic acid, α-linolenic acid, oleic acid, palmitic acid (C₁₆) and/or stearic acid (C₁₈).

The lipids described in U.S. Pat. No. 4,670,285 to Clandinin, herein incorporated by a reference, may be used in the infant formulas of the present invention. The lipids according to the Clandinin patent also may include certain fatty acids. These fatty acids include C₂₀ and C₂₂ ω-6 fatty acids and C₂₀ and C₂₂ ω-3 fatty acids. The fatty acids may be derivatives of egg yolk lipids blended with coconut oil and/or soybean oil. The fatty acids may be derivatives of red blood cell membranes. Alternativley, the fatty acids may be from fish or marine oils, such as, for example, oils from tilapia, menhaden, herring, caplin, and mixtures thereof. To more closely mimic human milk, the fatty acids may be blended with oils such as, for example, coconut oil, soybean oil, cocoa oil, palm oil, oleo oil, sunflower oil, and mixtures thereof.

Carbohydrate

The infant formulas of the present invention may include a carbohydrate. Generally, carbohydrates are compounds that consist of monosaccharide sugars. Carbohydrates have varying chain lengths. The general formula for carbohydrates is Cₘ(H₂O)ₙ. In living organisms, carbohydrates are important sources of energy. Carbohydrates may be classified by the number of sugar unit into monosaccharides (glucose, for example), disaccharides (saccharose, for example), oligosaccharides, and polysaccharides (starch, glycogen, and cellulose, for example).

The carbohydrates of the present invention may include any that are used in the food industry. Some examples of the carbohydrates that may be used in the infant formulas of the present invention may include: glucose, glucose polymers, dextrose, maltose, maltodextrin, maltrotiose, lactose, galactose, sucrose, sucanat, arabinose, ribose, xylose, fructose, levulose, psicose, sorbose, tagose, and sorbitol, and combinations thereof. The carbohydrates may be added as a component of another additive, such as, for example, refined sugar, brown sugar, molasses, corn syrup, maple syrup, fruit juices, fruit syrups, and other commercially available carbohydrates. The carbohydrates may come from the fucoidan. The infant formulas of the present invention may include at least about 5 weight percent, or at least about 8 weight percent, and less than about 15 weight percent, or less than about 11 weight percent total carbohydrates.

Fiber, also dietary fiber, is a carbohydrate. Fibers are within the class of polysaccharides, and are generally carbohydrates that cannot be digested. Fiber is present in most plants that are eaten for food, such as fruits, vegetables, grains, and legumes. The consumption of fiber in daily diet has been shown to increase various aspects of health, including: reducing the risk of heart disease, reducing the risk of type 2 diabetes, reducing the risk of diverticular disease, and reducing constipation. Though infants typically do not start to ingest fiber as part of their diet, U.S. Pat. No. 5,021,245 to Borschel, which is herein incorporated by a reference, illustrates an infant formula which includes fiber, and discloses a method for treating colicky infants by feeding them formula with fiber. The fiber concentration of the infant formula of the Borschel patent may be from about 3.5 to about 14 grams of fiber per liter of formula.

In one particular embodiment, the infant formula is directed for an infant of at least 6 months of age. Infants at such an age may need fiber, or may be able to have fiber as a part of their regular diet. The infant formula of this embodiment includes fiber in the amount of from about 0.2 to about 2 weight percent.

The total carbohydrates of the infant formulas of the present infant formula may include the fiber. In one embodiment, the fucoidan contains carbohydrates and fiber. In one embodiment, additional carbohydrates and/or fiber are included in the formula. The sources of fiber may include any fiber source known in the food arts. In one particular embodiment, the fiber includes a soy polysaccharide.

Additional Components

In addition to the other components of the various embodiments of the present invention, there are several other components that may be included in the baby or infant foods. There may be other natural components added to the infant formula composition. These natural components may include, for example, mangosteen, honey, aloe, sage, clove, ginger, rhubarb, sesame, chamomile, propolis, thyme, lavender, flower or blossom oils, olive oil, palm oil, coconut oil, beeswax, and so forth. One particularly beneficial natural ingredient is a derivative of the mangosteen plant. According to one embodiment, the present invention includes from about 0.01 to about 10 weight percent of a derivative of the mangosteen plant.

The Mangosteen plant (Garcinia mangostana L.) is a tropical fruit-bearing plant named after the French explorer Laurent Garcin. Many of the benefits of the mangosteen plant and its derivatives are descrived in U.S. Pat. No. 6,730,333, which is herein incorporated by a reference. Over the years, the mangosteen plant has been used in a number of different ways. The timber is used for cabinets, building materials, fencing and furniture. The pericarp, containing pectin, tannins, resins and a yellow latex, is used in tanning and dyeing leather black. The fruit pulp is mostly used as a dessert, but can also be canned or made into preserves. However, when removing the fruit pulp from the rind, care must be taken to prevent the tannins and resins of the cut pericarp from contacting the fruit pulp. The mangosteen rind, leaves and bark have also been used as ingredients in folk medicine in areas where the plant grows indigenously. The thick mangosteen rind is used for treating catarrh, cystitis, diarrhea, dysentery, eczema, fever, intestinal ailments, itch, and skin ailments. The mangosteen leaves arc used by some natives in teas and other decoctions for diarrhea, dysentery, fever, and thrush. It is also known that concoctions of mangosteen bark can be used for genitourinary afflictions and stomatosis.

Some of the medicinal properties of the Garcinia mangostana L. plant have been the subject of pharmacological and clinical studies. These studies have isolated chemical constituents in the mangosteen leaves, wood, pericarp and seed aril, which were found to contain the following biologically active compounds, among others: 1,6-dihydroxy-3-methoxy-2-(3-methyl-2-butenyl) xanthone, 1,5,8-trihydroxy-3-methoxy-2-(3-methyl-2-butenyl) xanthone, maclurin, 1,3,6,7-tetrahydroxy xanthone, 1,3,6,7-tetrahydroxy xanthone-O-β-D-glucoside, chrysanthemin, cyaniding-3-O-β-D-sophoroside, 8-deoxygartanin, 1,5-dihydroxy-2-isopentenyl-3-methoxy xanthone, 1,7-dihydroxy-2-isopentenyl-3-methoxy xanthone, 5,9-dihydroxy-8-methoxy-2,2-dimethyl-7-(3-methylbut-2-enyl)2(H), 6(H)-pyrano-(3,2,6)-xanthen-6-one, fructose, garcinone A, B, C, D and E, gartanin, glucose, cis-hex-3-enyl acetate, 3-isomangostin, 3-isomangostin hydrate, 1-isomangostin, 1-isomangostin hydrate, kolanone, mangostin, β-mangostin, α-mangostin, mangostin-3,6-di-O-gulcoside, normangostin, sucrose, tannins, BR-xanthone-A, BR-xanthone-B, calabaxanthone demethylcalabaxanthone, 2-(γ,γ-dimethylallyl)-1,7-dihydroxy-3-methoxyxanthone, 2,8-bis-(γ,γ-dimethylallyl)-1,3,7-trihydroxyxanthone, 1,3,5,8-tetrahydroxy-2,4-diprenylxanthone, and mangostanol. Many of these chemical constituents are xanthones, which are biologically active compounds that are receiving increasing interest in pharmacological studies for a variety of health benefits.

The infant formula composition may include a viscosity improving component. Viscosity improving components are commonly known it the food arts, and any of these may be included in the infant formulas of the present invention. The viscosity improving components may include those based on carbohydrates such as starches, starch derivatives and the like. Some particular viscosity improving components may include, for example, pregelatinised starches such as pregelatinised potato starch. The amount of viscosity improving components that may be used depends on the other components present in the formula such that the infant formula is from about 20 to about 100 cps as measured in a Brookfield viscometer at 30 rpm. Viscosity improving compositions and the appropriate amounts thereof are described, for example, in U.S. Pat. No. 6,863,918 to Bindels, as well as in EP 0 846 422 to Martinez.

The use of a viscosity improving component may provide several advantages, including, but not limited to prevention or reduction of regurgitation and/or excessive aerophagia (burps).

The infant formula composition may also include nutraceutical components having a high ORAC value. Free radicals are very reactive and highly destructive compounds in the body. Antioxidants that can be used in dietary supplements include β-carotene, vitamin E, vitamin C, N-acetyl cysteine, α-lipoic acid, selenium, and the like. Antioxidants having a high ORAC value are particularly desirable. Illustratively, nutraceutical antioxidants of high ORAC value that can be used in the present invention include concentrates of grape (red, black, or white), blueberry, acai fruit, raspberry, blackberry, strawberry, plum, orange, cherry, kiwi fruit, currant, elderberry, black currant, cranberry, mangosteen, noni, aronia, wolfberry, and mixtures thereof. Other high ORAC nutraceutical ingredients include proanthocyanidins, such as oligomeric proanthocyanidins, curcuminoids, and the like.

The infant formula composition may also include minerals such as, for example, iron, chloride, iodine, magnesium, zinc, selenium, copper, calcium, manganese, silicon, molybdenum, vanadium, sulfur, boron, nickel, tin, phosphorous, chromium, potassium, silver, gold, and so forth. Minerals serve a wide variety of essential physiological functions ranging from structural components of body tissues to essential components of many enzymes and other biological important molecules. Minerals are classified as micronutrients or trace elements on the basis of the amount present in the body. The seven micronutrients (calcium, potassium, sodium, magnesium, phosphorus, sulfur, and chloride) are present in the body in quantities of more than five grams. Trace elements, which include boron, copper, iron, manganese, selenium, and zinc are found in the body in quantities of less than five grams.

Calcium is the mineral element believed to be most deficient in the diet in the United States. Calcium intakes in excess of 300 mg per day are difficult to achieve in the absence of milk and dairy products in the diet. This is far below the recommended dietary allowance (RDA) for calcium (1000 mg per day for adults and children ages one to ten, 1200 mg per day for adolescents and pregnant and lactating women, which equates to about four glasses of milk per day). In fact, it has been reported that the mean daily calcium intake for females over age 12 does not exceed 85 percent of the RDA. In addition, during the years of peak bone mass development (18 to 30), more than 66 percent of all U.S. women fail to consume the recommended amounts of calcium on any given day. After age 35, this percentage increases to over 75 percent.

Although the general public is not fully aware of the consequences of inadequate mineral intake over prolonged periods of time, there is considerable scientific evidence that low calcium intake is one of several contributing factors leading to osteoporosis. In addition, the dietary ratio of calcium to phosphorous (Ca:P) relates directly to bone health. A Ca to P ratio of 1:1 to 2:1 is recommended to enhance bone marrowization in humans. Such ratios are difficult to achieve absent an adequate dietary supply of milk and dairy products, or an adequate supply of calcium and other minerals for the lactose-intolerant segment of the population.

Magnesium is the second most plentiful cation of the intracellular fluids. It is essential for the activity of many enzyme systems and plays an important role with regard to neurochemical transmission and muscular excitability. Deficits are accompanied by a variety of structural and functional disturbances. The average 70-kg adult has about 2000 mEq of magnesium in his body. About 50% of this magnesium is found in bone, 45% exists as an intracellular cation, and 5% is in the extracellular fluid. About 30% of the magnesium in the skeleton represents an exchangeable pool present either within the hydration shell or on the crystal surface. Mobilization of the cation from this pool in bone is fairly rapid in children, but not in adults. The larger fraction of magnesium in bone is apparently an integral part of bone crystal.

The average adult in the United States ingests about 20 to 40 mEq of magnesium per day in an ordinary diet, and of this about one third is absorbed from the gastrointestinal tract. The evidence suggests that the bulk of the absorption occurs in the upper small bowel. Absorption is by means of an active process apparently closely related to the transport system for calcium. Ingestion of low amounts of magnesium results in increased absorption of calcium and vice versa.

Magnesium is a cofactor of all enzymes involved in phosphate transfer reactions that utilize adenosine triphosphate (ATP) and other nucleotide triphosphates as substrates. Various phosphatases and pyrophosphatases also represent enzymes from an enormous list that are influenced by this metallic ion.

Magnesium plays a vital role in the reversible association of intracellular particles and in the binding of macromolecules to subcellular organelles. For example, the binding of messenger RNA (mRNA) to ribosomes is magnesium dependent, as is the functional integrity of ribosomal subunits. Certain of the effects of magnesium on the nervous system are similar to those of calcium. An increased concentration of magnesium in the extracellular fluid causes depression of the central nervous system (CNS). Hypomagnesemia causes increased CNS irritability, disorientation, and convulsions. Magnesium also has a direct depressant effect on skeletal muscle. Abnormally low concentrations of magnesium in the extracellular fluid result in increased acetylcholine release and increased muscle excitability that can produce tetany.

Boron is required by the body in trace amounts for proper metabolism of calcium, magnesium, and phosphorus. Boron helps brain function, healthy bones, and can increase alertness. Boron is also useful for people who want to build muscle. Boron is known to help prevent postmenopausal osteoporosis. Further, a relationship has been shown between a lack of boron in the diet and the chances of developing arthritis. R. E. Newnham, 46 Journal of Applied Nutrition (1994).

Chromium is an important trace element wherein the lack of sufficient chromium in the diet leads to impairment of glucose utilization, however, disturbances in protein and lipid metabolism have also been observed. Impaired glucose utilization occurs in many middle-aged and elderly human beings. In experimental studies, significant numbers of such persons have shown improvement in their glucose utilization after treatment with chromium. Chromium is transported by transferrin in the plasma and competes with iron for binding sites. Chromium as a dietary supplement may produce benefits due to its enhancement of glucose utilization and its possible facilitating the binding of insulin to insulin receptors, which increases its effects on carbohydrate and lipid metabolism. Chromium as a supplement may produce benefits in atherosclerosis, diabetes, rheumatism, and weight control.

Copper is another important trace element in the diet. The most common defect observed in copper-deficient animals is anemia. Other abnormalities include growth depression, skeletal defects, demyelination and degeneration of the nervous system, ataxia, defects in pigmentation and structure of hair or wool, reproductive failure and cardiovascular lesions, including dissecting aneurisms. Several copper-containing metalloproteins have been isolated, including tyrosinase, ascorbic acid oxidase, laccase, cytochrome oxidase, uricase, monoamine oxidase, δ-aminolevulinic acid hydrydase, and dopamine-β-hydroxylase. Copper functions in the absorption and utilization of iron, electron transport, connective tissue metabolism, phospholipid formation, purine metabolism, and development of the nervous system. Ferroxidase I (ceruloplasmin), a copper-containing enzyme, effects the oxidation of Fe(II) to Fe(III), a required step for mobilization of stored iron. A copper-containing enzyme is thought to be responsible for the oxidative deamination of the epsilon amino group of lysine to produce desmosine and isodesmosine, the cross-links of elastin. In copper-deficient animals the arterial elastin is weaker and dissecting aneurisms may occur.

Iodine is important for the production of thyroid hormones, which regulate cellular oxidation. The iodine-deficiency disease is goiter. In iodine-deficient young, growth is depressed and sexual development is delayed, the skin and hair are typically rough, and the hair becomes thin. Cretinism, feeble-mindedness, and deaf-mutism occur in a severe deficiency. There is reproductive failure in females and decreased fertility in males that lack sufficient iodine in the diet.

Iron is an essential component of several important metalloproteins. These include hemoglobin, myoglobin, and many oxidation-reduction enzymes. In iron deficiency, there may be reduced concentrations of some of the iron-containing enzymes, such as cytochrome c in liver, kidney, and skeletal muscle, and succinic dehydrogenase in the kidney and heart.

Manganese plays a role in the synthesis of GAGs, collagen, and glycoproteins, which are important constituents of cartilage and bone. Manganese is required for enzyme activity of glycosyltransferases. This family of enzymes is responsible for linking sugars together into GAGs, adding sugars to other glycoproteins, adding sulfate to aminosugars, converting sugars to other modified sugars, and adding sugars to lipids. These functions are manifested as GAG synthesis (hyaluronic acid, chondroitin sulfate, karatan sulfate, heparin sulfate, and dermatin sulfate, among others), collagen synthesis, and function of many other glycoproteins and glycolipids. GAGs and collagen are chief structural elements for all connective tissues. Their synthesis is essential for proper maintenance and repair of connective tissues.

Manganese deficiencies in humans and animals lead to abnormal bone growth, swollen and enlarged joints, and slipped tendons. In humans, manganese deficiencies are associated with bone loss, arthritis, and impaired glucose utilization. Levels of all GAGs are decreased in connective tissues during manganese deficiencies, with chondroitin sulfates being most depleted. Manganese-deficient organisms quickly normalize GAG and collagen synthesis when manganese is provided.

Manganese is also required for activity of manganese superoxide dismutase (MnSOD), which is present only in mitochondria. Manganese deficiency decreases the activity of MnSOD and may lead to mitochondrial dysfunction, manifested as decreased cellular functions. Manganese is required for the conversion of mevalonic acid to squalene. Pyruvate carboxylase is a manganese metalloenzyme, repressible by insulin, important in the citric acid cycle for the oxidation of carbohydrates, lipids, and proteins, as well as in the synthesis of glucose and lipids.

Molybdenum is an essential mineral found in highest concentrations in the liver, kidneys, skin, and bones. This mineral is required by the body to properly metabolize nitrogen. It is also a vital component of the enzyme xanthine oxidase, which is required to convert purines to uric acid, a normal byproduct of metabolism. Molybdenum also supports the body's storage of iron and other cellular functions such as growth. A deficiency of molybdenum is associated with mouth and gum disorders and cancer. A diet high in refined and processed foods can lead to a deficiency of molybdenum, resulting in anemia, loss of appetite and weight, and stunted growth in animals. While these deficiencies have not been observed directly in humans, it is known that a molybdenum deficiency can lead to impotence in older males.

Selenium is an essential trace element that functions as a component of enzymes involved in protection against antioxidants and thyroid hormone metabolism. In several intra- and extra-cellular glutathione peroxidases and iodothyronine 5′-deiodinases, selenium is located at the active centers as the selenoamino acid, selenocysteine (SeCYS). At least two other proteins of unknown function also contain SeCYS. Although SeCYS is an important dietary form, it is not directly incorporated into these specific selenium-proteins; instead, a co-translational process yields tRNA-bound SeCYS. In contrast, selenium as seleno-methionine is incorporated non-specifically into many proteins, as it competes with methionine in general protein synthesis. Therefore, tissues often contain both specific, as well as the nonspecific, selenium-containing proteins when both SeCYS and selenomethionine are consumed, as found in many foods. Selenium is a major antioxidant nutrient and is involved in protecting cell membranes and preventing free radical generation, thereby decreasing the risk of cancer and disease of the heart and blood vessels. Medical surveys show that increased selenium intake decreases the risk of breast, colon, lung and prostate cancer. Selenium also preserves tissue elasticity; slows down the aging and hardening of tissues through oxidation; and helps in the treatment and prevention of dandruff. Recent research has shown antitumorigenic effects of high levels of selenium in the diets of several animal models.

Vanadium is an essential nutrient beneficial for thyroid hormone metabolism. The daily requirement necessary to prevent a deficiency is about 10 to 20 micrograms a day. Vanadium deficiency can lead to slow growth, defective bones, and altered lipid metabolism. Vanadium exerts an insulin-like effect in some respects, and there has been a considerable amount of research on vanadium and diabetes. In insulin dependent diabetics, vanadium has been found to reduce the amount of insulin required to manage the disease, and in non-insulin dependent diabetics, vanadium has been known to control the condition altogether. Research has shown that supplementation with vanadium leads to an increase in glucose transport into cells, which suggests that vanadium supplementation of the diet improves glucose metabolism and may aid in preventing diabetes.

Zinc is known to occur in many important metalloenzymes. These include carbonic anhydrase, carboxypeptidases A and B, alcohol dehydrogenase, glutamic dehydrogenase, D-glyceraldehyde-3-phosphate dehydrogenase, lactic dehydrogenase, malic dehydrogenase, alkaline phosphatase, and aldolase. Impaired synthesis of nucleic acids and proteins has been observed in zinc deficiency. There is also evidence that zinc may be involved in the secretion of insulin and in the function of the hormone.

According to the present invention, minerals can be provided as inorganic compounds, such as chlorides, sulfates, and the like. In addition, some minerals can be provided in more bioavailable forms, such as amino acid chelates, which are well known in the art. U.S. Pat. No. 5,292,538. Examples of minerals that can be provided as amino acid chelates include calcium, magnesium, manganese, zinc, iron, boron, copper, molybdenum, and chromium. Still further, minerals can be provided as deep sea minerals.

The infant formula composition may also include vitamins such as, for example, vitamin A (retinol), vitamin B₁ (thiamine), vitamin B₂ (riboflavin, also known as vitamin G), vitamin B₃ (niacin, also known as vitamin P), vitamin B₅ (pantothenic acid), vitamin B₆ (pyridoxine), vitamin B₇ (biotin, also known as vitamin H), vitamin B₉ (folic acid, also known as vitamin M), vitamin B₁₂ (cyanocobalamin), vitamin C (ascorbic acid), vitamin D₁ (lamisterol), vitamin D₂ (ergocalciferol), vitamin D₃ (calciferol), vitamin D₄ (dihydrotachysterol), vitamin D₅ (7-dehydrositosterol), vitamin E (tocopherol), vitamin K (naphthoquinone), and so forth.

The infant formula composition may also include other nutrients and additives such as, for example, ω-3 fatty acids (such as DHA, ARA, and so forth); ω-6 fatty acids; proteins; amino acids including but not limited to tryptophan and methionine; fats; cholesterols; sugars; polysaccharides; choline; lycopene; lutein; zeaxanthin; potassium citrate; calcium carbonate; ascorbic acid; potassium chloride; choline bitartrate; magnesium chloride; choline hloride; ferrous sulfate; ascorbyl palmitate; taurine; m-inositol; d-alpha-tocopheryl acetate; L-carnitine; mixed tocopherols; sodium chloride; zinc sulfate; niacinamide; calcium pantothenate; cupric sulfate; vitamin A palmitate; thiamine chloride hydrochloride; riboflavin; pyridoxine hydrochloride; manganese sulfate; phylloquinone; biotin; sodium selenate; cyanocobalamin; adenosine 5′-monophosphate, cytidine 5′-monophosphate, disodium guanosine 5′-monophosphate, disodium uridine 5′-monophosphate; beta-carotene; sweeteners such as momordica fruit, corn syrup, sucrose, dextrose, fructose, crystalline fructose, lactose, malt syrup, malt syrup solids, rice syrup solids, rice syrup, sorghum syrup, invert sugar, refiners syrup, corn syrup, corn syrup solids, maltose, high fructose corn syrup, honey, molasses, sugar alcohols, maltodextrin, and so forth; plant extracts such as green tea extract, grape seed extract, and so forth.

The infant formula composition may also include flavonoids. The flavonoids may include those from the groups of flavonols, flavones, flavonones, flavon-3-ols, isoflavones, and anthocyanidins. Some non-limiting examples of edible flavonoids may include, for example, quercetin, rutin, hesperidin, naringin, tangeritin, proanthocyanidins, epicatechin, myricetin, quercetin, kaempferol, luteolin, apigenin, and the like.

The infant formula composition may also include anti-oxidants or oxidant scavengers in addition to those that may be present in the fucoidan. Free radicals are products of oxidative deterioration of such substances as polyunsaturated fat. Antioxidants convert free radicals into a less reactive and nonharmful chemical form. Some examples of anti-oxidants include bioflavonoids, amino acids, silymarin, curcumin, all-trans beta-carotene, cis beta-carotenes, all-trans alpha-carotene, cis alpha-carotenes, all-trans lycopene, cis lycopenes, all-trans gamma-carotene, cis gamma-carotenes, zeta-carotene, phytofluene, phytoene, vitamin C and vitamin E and the like.

The infant formula composition may include an emulsifier. Any emulsifiers capable of being used in the art of foods may be used. Emulsifiers may be needed when additives in the infant formula composition do not dissolve in the infant formula. For example, some lipids may not dissolve in a water-based infant formula. With an emulsifier present, these non-soluble components may be substantially evenly disbursed throughout the infant formula instead of collecting at a common location within the infant formula.

The infant formula composition may also include other nutraceutical component having a high ORAC value. Such nutraceutical components may include, for example, concentrates of black grapes, red grapes, white grapes, blueberry, acai fruit, raspberry, blackberry, strawberry, plum, orange, cherry, kiwi fruit, currant, elderberry, black currant, cranberry, mangosteen, noni, aronia, wolfberry, proanthocyanidins (such as from grape seed extract), curcuminoids, or mixtures thereof.

Forms

The infant formulas of the present invention may be in any form capable of consumption, or capable of dissolving, combining, or diluting for consumption. Typically, infant formulas are available in three forms. In one form, the infant formula is available to the consumer in a ready-to-consume form. In this ready-to-consume form, the infant formula may be packaged in a bottle with a standard threaded top shaped to receive a standard bottle nipple. The ready-to-consume forms are the most convenient for consumers, and if used within a time period before the formula degrades, are sure to have the correct concentration for the infant. Ready-to-consume forms, however, typically have a shorter shelf life than other forms, create more waste, and are more costly to transport.

The infant formula of the present invention may be in a ready-to-consume form. It may be packaged according to the disclosure below. It may be packaged in containers suitable for infant formula compositions, such as, for example, single-use containers, bulk containers, and so forth.

Another form in which infant formulas are often sold is a concentrated form. The concentrated forms include both a liquid concentrated form, and a substantially dehydrated concentrated form. Both forms require that a diluting agent be added to the concentrate before it is ready to consume. The liquid concentrate has the advantage that less diluting agent need be added for consumption, and complete dissolution of the concentrate in the diluting agent is more probable than with the substantially dehydrated form. The liquid concentrate, however, is more expensive to transport, creates more waste, and typically has a shorter shelf life than the substantially dehydrated form, however.

The infant formula of the present invention may be in a liquid concentrate form. The liquid concentrate may be made by any method known in the food arts of making a liquid concentrate. In one embodiment, a ready-to-consume form of infant formula is concentrated by removal of some of the water. Removal of some of the water may be by any means known in the art, such as evaporation, vaccum evaporation, high temperature evaporation, ultra high temperature evaporation, and the like. Alternatively, separate components of the infant formula may be added in higher concentrations than in the ready-to-use form. Many of the components of the infant formula of the present invention exist in a substantially dehydrated, powder, concentrated, or slurry form that need diluting before consumption. By mixing the various components without diluting, a concentrate may be formed. Sufficient diluting agent may be added to the concentrate such that the soluble components of the infant formula sufficiently dissolve in the diluting agent.

Dehydrated infant formulas are also typically available. Dehydrated infant formulas may be made by dehydrating methods known in the food arts. Some examples of dehydrating methods include vacuum drying, freeze drying, spray drying, and the like. Dehydrated infant formulas may be in the form of a powder, grains, flakes, pellets, or the like. Dehydrated infant formulas have the advantage of being lighter, less expensive and easier to ship, typically have a longer shelf life, create less waste, and typically have a longer period between the time they are opened and the time they spoil or degrade. Unlike the ready-to-consume and liquid concentrate, which must be used within a certain amount of time after they are opened, the dehydrated infant formulas typically may last longer after being opened. This gives rise to the particular advantage of then being available in a bulk form with many servings. The disadvantages of the dehydrated form include inconvenience in measurement and mixing, difficulty in mixing, as simple addition of a diluting agent to the formula often does not result in a solution without mechanical agitation, heating, or other methods of increasing solubility.

The infant formula of the present invention may be provided in a substantially dehydrated form. In one embodiment, the substantially dehydrated form may be produced by dehydrating a ready-to-consume form of the infant formula. In another embodiment, the substantially dehydrated form may be produced by dehydrating a concentrated form of the infant formula. In yet another embodiment, the components, or combinations of the components of the infant formula may be substantially dehydrated piecewise (unless they are already in a substantially dehydrated state), and the substantially dehydrated components then combined and mixed. The components and/or combinations of components may be substantially dehydrated by any means known in the art, such as those listed herein.

The infant formulas of the present invention may include combinations of the forms typically available for infant formulas. Separate components of the infant formula composition may be sold in a ready-to consume liquid, and other components may be sold in a concentrated form. For example, the fucoidan and lipids may be in a ready-to-consume form, and other additives may be in a substantially dehydrated form. The consumer may add the substantially dehydrated additives to the ready-to-consume portion if desired before consumption. This embodiment may be especially advantageous when the consumer desires to include only specific additives in the infant formula, such as fiber, preservatives, and the like.

Concentrates may be diluted with any diluting agent known in the art of foods. The diluting agent may include, for example, water, milk, fruit juice, vegetable juice, fruit extracts, vegetable extracts, and the like. Fruit and vegetable extracts may include, for example, a fruit or vegetable stock which may be made by cooking a fruit and/or vegetable in water, and then removing the fruit and/or vegetable from the liquid. Further, the diluting agent may be a fortified diluting agent. In one embodiment, the diluting agent is a vitamin and/or mineral fortified water.

Infant Formula Composition Kit

Also disclosed is an infant formula composition kit for mixing by the consumer. Consumers demand that products be safe and convenient. As the forms of infant formulas may include advantages and disadvantages as to their convenience, safety, and so forth, the kits of the present invention may be designed to provide the most advantageous combination of parts to maximize safety and convenience for the consumer, as well as save expense in shipping for the manufacturer.

The kits of the present invention may include an infant formula concentrate and a diluting agent. The infant formula concentrate may be any as described above. The infant formula concentrate may be dehydrated. The level of dehydration may be such that substantially all of the water is removed, or such that only a portion of the water is removed. The diluting agent may be any described above. In one embodiment, the infant formula concentrate is a substantially dehydrated concentrate, with substantially all of the water removed. In one embodiment the diluting agent is water. The water may be fortified with vitamins and/or minerals as described herein. Further, the diluting agent may include any of the components that may be most difficult to dehydrate, such as lipids and/or proteins, for example. The diluting agent may also include an emulsifier so that the lipids may dissolve in a polar diluting agent. Also, the diluting agent may include components that may degrade during the steps of dehydration. The water and/or formula concentrate may be packaged according to any of the embodiments illustrated below, or any other packaging method known in the art.

According to another embodiment, the kit may include an infant formula composition in a ready-to-drink form according to any of the embodiments described above, and additives in a concentrated form. The additives may include any that are described hereinabove, and may be also included in the ready-to-drink infant formula composition. The additives may be in a substantially dehydrated form. The additives may include fiber. In one embodiment, the ready-to-drink infant formula composition includes fucoidan, a lipid and a protein. The additives may include substantially dehydrated vitamins, minerals, proteins, carbohydrates, fiber, ω-3 fatty acids, and so forth. The additives may be mixed or separate. For example, the kit may include the ready-to-drink form of the infant formula composition, and the additives include substantially dehydrated vitamins, packaged separately from the substantially dehydrated fiber, packaged separately from the substantially dehydrated carbohydrates, packaged separately from the ω-3 fatty acids, and so forth. These embodiments have the particular advantage in that the consumer may better decide which additives are to be included in the infant formula for consumption by the infant. In use, the additives may be added to the infant formula composition in ready-to-drink form before consumption by the infant.

Packaging

Liquid or hydrated infant formula compositions may be packaged before use and/or consumption. These infant formula compositions may be packaged in jars, bottles, cans, or the like. These infant formula compositions and/or the packaging may be sterilized so as to increase the probable shelf life of the infant formula composition, and/or decrease the probability that the food will spoil before it is consumed. The process of sterilization follows the mixing of the several components of the infant formula composition. Once all components are mixed in hydrated or rehydrated form, the mixture is sterilized by pasteurization or other heating techniques. Although pasteurization (at least 87.8° C. or 190° F.) effectively eliminates pathogenic microorganisms, sterilization at higher temperatures may be needed to eliminate all microorganisms.

In achieving the necessary sterilization, two different sterilization processes are typically used. Using the HTST (high temperature short time) process, the mixture may be raised to about 85° C. (185° F.) for about 20-30 seconds. Alternately, the ultra-high temperature (UHT) process involves raising the temperature of the mixture to about 140.6° C. (285° F.) for about 4-6 seconds. In either process, immediately after the heating step, the temperature is rapidly lowered to at least ambient temperatures of about 21.1-26.7° C. (70-80° F.). Alternately, the mixture may be chilled down to about 4.4° C. (40° F.).

Heating of the mixture may be accomplished by direct or indirect heating. For example, the mixture may be heated by direct contact with steam or indirectly by a selected type of heat exchanger.

The sterilized blend may then be poured into containers, using a hot-fill or cold-fill method. In the hot-fill process, the product is first heated to temperatures for pasteurization, HTST, or UHT. Then it is poured into containers at elevated temperatures to kill any microorganisms inside the container. The use of preservatives, such as sodium benzoate and potassium sorbate may be used. The pH is usually maintained below 4.4, possibly using acids such as lemon juice or vinegar. After filling, the infant formula composition and infant formula composition may be cooled slowly by a water mist. Filling of containers may be done by aseptic processing and packaging methods, which are well known in the art.

In the cold-fill process, after pasteurization or sterilization temperatures are reached, the product is immediately cooled to about room temperature prior to packaging, using aseptic processing and packaging techniques. Immediate cooling allows less vitamin degradation and variations in flavor that may be found in the hot-fill process. Thus, in cold-fill processing the flavor may be cleaner and fresher. Preservatives may be included to control the growth of yeast, molds, and bacteria.

The cold-fill process is compatible with use of high-density polyethylene (HDPE) or polyethylene terephthalate (PET) packaging, so as to not compromise the integrity of the package structure. The containers may be capable of holding only a single serving of the infant formula composition.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An infant formula composition comprising: fucoidan, a protein, and a lipid.

2. The infant formula composition of claim 1, wherein the fucoidan is partially hydrolyzed.

3. The infant formula composition of claim 1, wherein the fucoidan is sulfonated.

4. The infant formula composition of claim 1, wherein the fucoidan is a derivative of one of the group of: Japanese mozuku seaweed, Japanese kombu seaweed, Tongan limu moui seaweed, and combinations thereof.

5. The infant formula composition of claim 1, wherein the protein comprises a derivative of quinoa.

6. The infant formula composition of claim 1, further including an ω-3 fatty acid.

7. A concentrated infant formula composition kit that can be mixed in the field, wherein the kit includes: a dehydrated infant formula composition comprising fucoidan and a lipid; and a diluting agent.

8. The kit of claim 7, wherein the diluting agent comprises water and a mineral.

9. The kit of claim 7, wherein the diluting agent comprises water and a vitamin.

10. The kit of claim 7, wherein the dehydrated infant formula composition is substantially completely dehydrated.

11. The kit of claim 7, wherein the dehydrated infant formula is a concentrated liquid.

12. The kit of claim 7, wherein the fucoidan is partially hydrolyzed.

13. The kit of claim 7, wherein the fucoidan is sulfonated.

14. The kit of claim 7, further comprising a protein derived from quinoa.

15. An infant formula composition kit that can be mixed in the field, wherein the kit includes: an infant formula composition, comprising fucoidan and a lipid; and an additive in concentrated form.

16. The kit of claim 15, wherein the fucoidan is partially hydrolyzed.

17. The kit of claim 15, wherein the fucoidan is sulfonated.

18. The kit of claim 15, wherein the infant formula composition further includes a protein derived from quinoa.

19. The kit of claim 15, wherein the additive includes a protein derived from quinoa.

20. The kit of claim 15, wherein the additive includes dietary fiber.
